(19) United States
(12) Patent Application Publication
(10) Pub. No.: US 2015/0236463 A1
(43) Pub. Date: Aug. 20, 2015

(54) CONNECTING MODULE AND CONNECTOR

(71) Applicant: GENESIS ELECTRO-MECHANICAL INC., Guan Lan Shenzhen (CN)

(72) Inventors: Zhou CHEN, Guan Lan Shenzhen (CN); Yi-Fei LUO, Guan Lan Shenzhen (CN)

(73) Assignee: GENESIS ELECTRO-MECHANICAL INC., Guan Lan Shenzhen (CN)

(21) Appl. No.: 14/455,659

(22) Filed: Aug. 8, 2014

(30) Foreign Application Priority Data
Feb. 14, 2014 (CN) 201420067186.8

(51) Int. Cl. H01R 27/02

(52) U.S. Cl. CPC H01R 27/02

(57) ABSTRACT

A connector is provided, which includes: a base, a first external connecting part disposed on the base, and a second external connecting part disposed on the base. The first external connecting part has a first terminal in a USB type. The second external connecting part has a second terminal in an eSATA type. When the connector is in use, either USB or eSATA connection can be selected accordingly.

### CROSS-REFERENCE TO RELATED APPLICATIONS

The present application claims priority to Chinese Application No. 201430067186.8, filed Feb. 14, 2014, which is expressly incorporated by reference herein.

### FIELD

The present application relates to connectors, and, more particularly, to a connector with multiple functions.

### BACKGROUND

As the technology for developing electronic products rapidly grows, the design of electronic products is focusing on the concept of practicality and multiple functionality. A connector is used to be electrically connected with cables, printed circuit boards, and other electronic elements, which are widely used in all kinds of electronic products, such as computers, notebooks and mobile phones.

Typically, a connector is connected with a specific type of circuits. For examples, the SATA (Serial Advanced Technology Attachment) circuit is only capable of being connected with a SATA connector.

However, multiple connectors are often required to be connected to a single electronic device having multiple types of circuits, which undesirably increases the size of the electronic device, thereby making it harder to achieve the requirement of miniaturization.

Therefore, there is an urgent need in solving the foregoing problems.

### SUMMARY

In light of the foregoing drawbacks, the present disclosure proposes a connector, which can selectively choose eSATA or USB as a connection means.

The connector proposed by the present disclosure comprises: a base; a first external connection part disposed on the base and having a first terminal in a Universal Serial Bus (USB) type; and a second external connection part disposed on the base and having a second terminal in an external Serial Advanced Technology Attachment (eSATA) type.

In an embodiment, the first external connection part is stacked on the second external connection, and the second external connection part is fixed on the base.

In an embodiment, the connector further comprises a fixing member disposed on the base to fix an element coupled with the connector.

In an embodiment, the connector further comprises a housing that accommodates the base, the first external connection part, and the second external connection part.

In an embodiment, the connector is coupled to the USB device. For example, an USB device is coupled to the external part to be electrically connected with the first terminal.

In an embodiment, the connector, if coupled with an adaptor, is a connecting module. For example, the adaptor has an electrical connecting port for coupling with the second external connection part, and the electrical connection port has an eSATA wire for being electrically connected with the second terminal

In an embodiment, the adaptor has a fixing member to prevent the eSATA wire from falling off.

In an embodiment, the connector further comprises a first fixing member disposed on the base, and the adaptor has a second fixing member coupled with the first fixing member in order to securely fix the connector and the adaptor in place.

In summary, the present disclosure has two types of connection wires (i.e., USB and eSATA) incorporated in the same connector, such that the connector can selectively choose eSATA or USB connection for signal communication, allowing a single electronic product to have multiple selections of wire choice, as well as to reduce the size of the electronic produce by incorporating two type of connectors in one connector, thereby desirably achieving the goal of miniaturization.

### BRIEF DESCRIPTION OF THE DRAWINGS

The present disclosure can be more fully understood by reading the following detailed description of the preferred embodiments, with reference made to the accompanying drawings, wherein:

FIG. 1 is an isometric view of a connecting module according to the present disclosure;

FIG. 2 is an exploded view of a connector according to the present disclosure; and

FIG. 3 is an exploded view of an adaptor according to the present disclosure.

### DETAILED DESCRIPTION OF THE PREFERRED EMBODIMENTS

The present disclosure is described in the following with specific embodiments, so that one skilled in the pertinent art can easily understand other advantages and effects of the present disclosure from the disclosure of the present disclosure.

It is to be understood that the scope of the present disclosure is not limited to the disclosed embodiments. On the contrary, it is intended to cover various modifications and similar arrangements. The scope of the claims, therefore, should be accorded the broadest interpretation so as to encompass all such modifications and similar arrangements. In addition, words such as “on”, “top” and “a” are used to explain the preferred embodiment of the present disclosure only and should not limit the scope of the present disclosure.

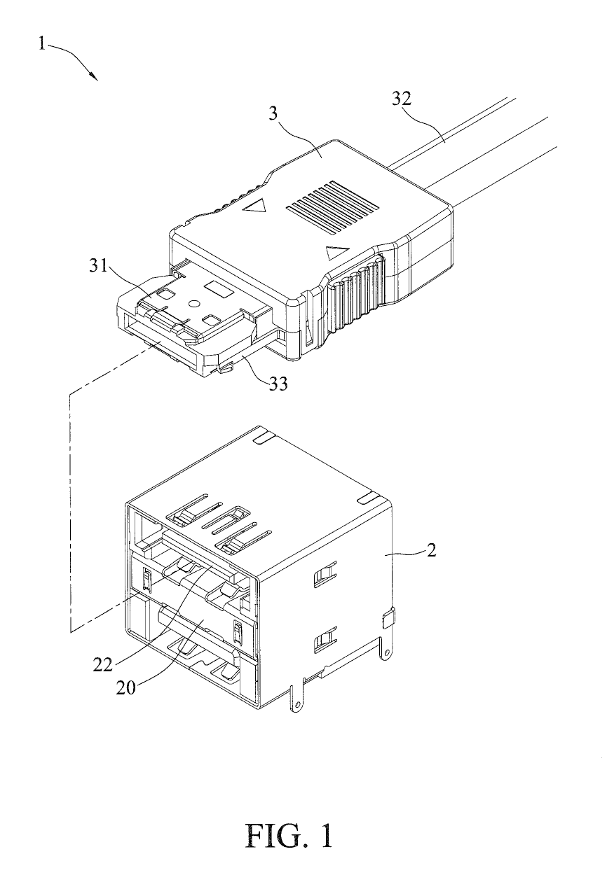

FIG. 1 is an exploded view of a connecting module 1 according to the present disclosure. The connecting module 1 comprises a connector 2 and an adaptor 3 connected with the connector 2.

In an embodiment, the connector 2 is a socket, and the adaptor 3 is a plug.

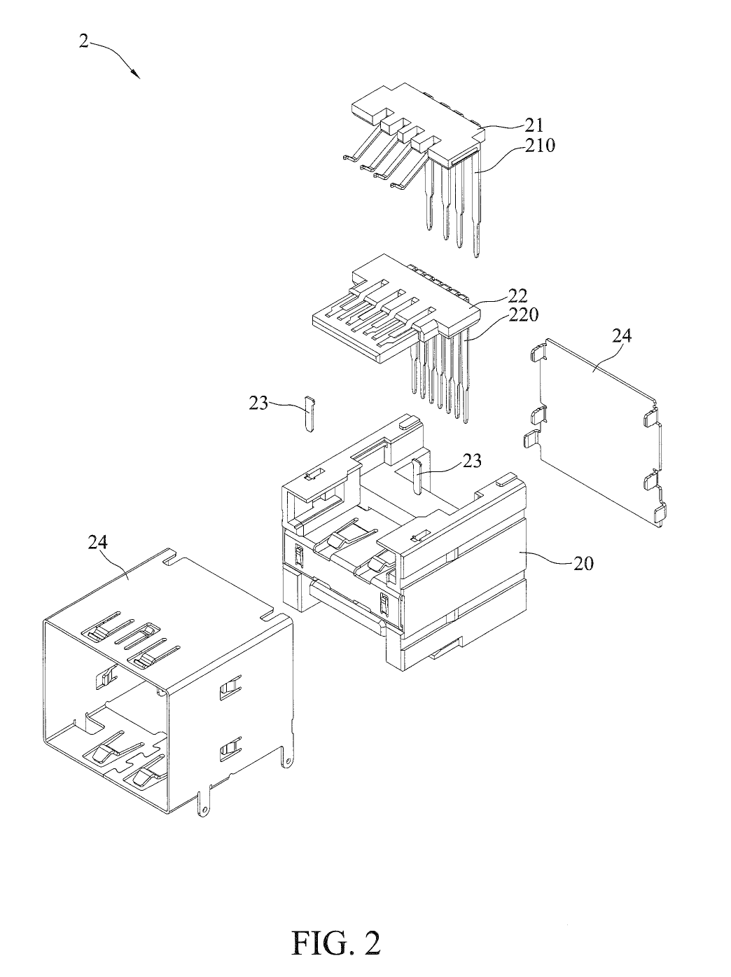

As shown in FIG. 2, the connector 2 comprises a base 20, a first external connecting part 21 disposed on the base 20, a second external connecting part 22 disposed on the base 20, two first fixing members 23 disposed on the base, and a first housing 24 that accommodates the base 20, the first external connecting part 21, the second external connecting part 22, and the first fixing members 23.

The first external connecting part 21 is stacked on the second external connecting part 22, and the first external connecting part 21 has a first terminal 210 in a USB type. In an embodiment, the first terminal 210 downwardly extends to be exposed to the bottom of the first housing 24.

The first fixing member 23 is a metal plate, passing through the via of the base 20 to be fixed on the base and coupled with the adaptor 3.

The first housing 24 is disposed on the top, bottom, left, right, and back of the connector 2, allowing the base 20, the first external connecting part 21, and the second connecting part 22 to be exposed from the front side of the housing 24.

The connector 2 incorporates two types of wire terminals (USB and eSATA) to provide two choices for external connection.

Besides, the connector 2, which has the base 20, the first external connecting part 21, and the second external connecting part 22 that are three detachable, can be assembled easily.

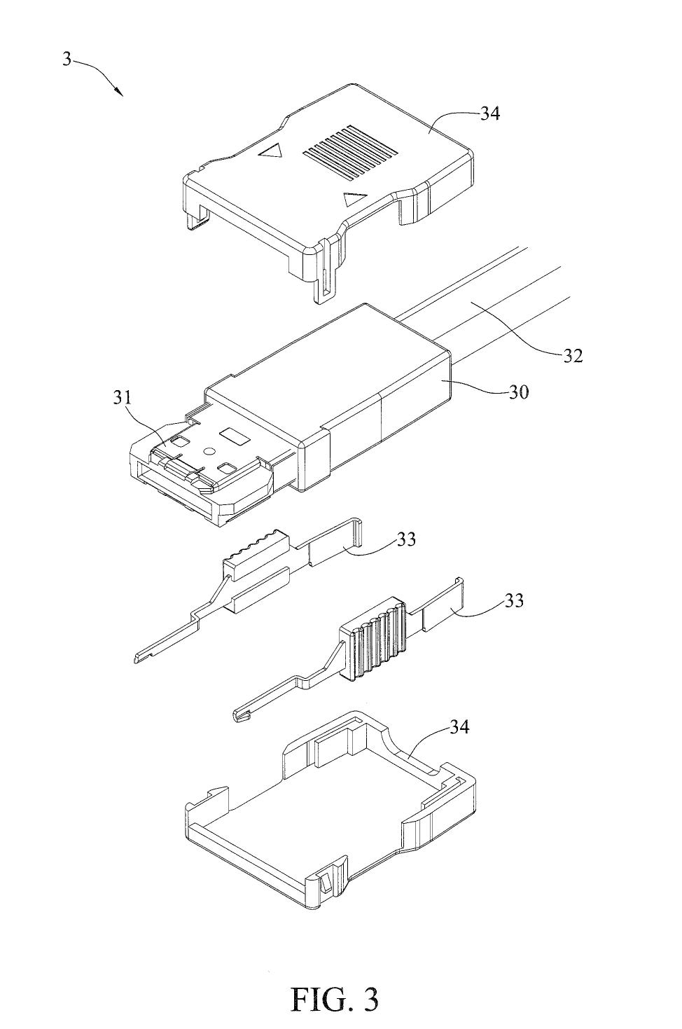

As shown in FIG. 3, the adaptor 3 comprises a main body 30 having an electrical connection port 31, two fixing member 33 disposed on the left and right sides of the main body 30, and a second housing 34 that accommodates the main body 30 and the two fixing members 33.

The electrical connection port 31 is coupled with the second external connecting part 22 of the connector 2, and the electrical connection port 31 has an eSATA wire to allow the electrical connection port 31 to be electrically connected with the second terminal 220. In an embodiment, the eSATA wire 32 passes through the main body 30 to be electrically connected with the terminals inside of the electrical connection port 31.

The second fixing member 33 is in a shape of a long rod, with a hoop in the front, to securely hook the first fixing member 23, so as to fix the connector 2 and the adaptor 3 in place. The second fixing member 33 abuts between the main body 30 and the second housing 34, to avoid the movement of the main body 30, thereby preventing the eSATA wire 32 from falling off.

The second housing 34 is divided into an upper part and a lower part, allowing the electrical connection port 31 and the second fixing member 33 to project from the front of the second housing 34, and the eSATA wire 32 extends beyond the back of the second housing 34.

Thus, when the connector 2 is in use, the adaptor 3 is connected with the connector 2 to allow eSATA signal communication, as shown as the connecting module 1 in FIG. 1. Alternatively, a USB device can be connected with the connector 2 to allow USB signal communication.

In summary, the connector proposed by present disclosure has multiple wire communication means in a single electronic product, and the space for accommodating two connecting modules is now reduced to only need to accommodate one connecting module, as a result the size of the overall electronic product can be further reduced to meet the requirement of miniaturization.

The present disclosure has been described using exemplary preferred embodiments. However, it is to be understood that the scope of the present disclosure is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A connector comprising:
a base;
a first external connecting part disposed on the base and having a first terminal in a universal serial bus (USB) type; and
a second external connecting part disposed on the base and having a second terminal in an external serial advanced technology attachment (eSATA) type.

2. The connector of claim 1, wherein the first external connecting part is stacked on the second external connecting part.

3. The connector of claim 1, wherein the second external connecting part is secured on the base.

4. The connector of claim 1, further comprising a fixing member disposed on the base to securely fix an element adapted with the connector.

5. The connector of claim 1, further comprising a housing that accommodates the base, the first external connecting part and the second external connecting part.

6. A connecting module comprising:
a connector comprising a base, a first external connecting part disposed on the base and having a first terminal in a USB type, and a second external connecting part disposed on the base and having a second terminal in an eSATA type; and
an adaptor adapted with the connector and having an electrical connecting port coupled with the second external connecting part, wherein the electrical connecting port has an eSATA wire for being electrically connected with the second terminal.

7. The connecting module of claim 6, wherein the connector further comprises a fixing member disposed on the base to securely fix the adaptor to the connector.

8. The connecting module of claim 6, wherein the adaptor further comprises a fixing member to avoid the eSATA wire from falling off.

9. The connecting module of claim 6, wherein the connector further comprises a first fixing member disposed on the base, and the adaptor further comprises a second fixing member coupled with the first fixing member such that the adaptor is securely fixed to the connector.

10. The connecting module of claim 6, wherein the connector further comprises a housing to accommodate the base, the first external connecting part, and the second external connecting part.
